(19) United States
(12) Patent Application Publication
(10) Pub. No.: US 2001/0045135 A1
(43) Pub. Date: Nov. 29, 2001

(54) Ring shaped magnetostrictive type torque sensor

(76) Inventors: Masashi Horiuchi, Nagano-ken (JP); Hiroyuki Wakiwaka, Nagano-ken (JP)

Correspondence Address: William C. Rowland, BURNS, DOANE, SWECKER & MATHIS, L.L.P, P.O. Box 1404, Alexandria, VA, 22313-1404, US

(21) Appl. No.: 09/820,879

(22) Filed: Mar. 30, 2001

(30) Foreign Application Priority Data
Apr. 5, 2000 (JP) P-2000-103374

(51) Int. Cl. G01L 3/02

(52) U.S. Cl. 73/862.333

(57) ABSTRACT

A ring shaped magnetostrictive torque sensor includes a ring core functioning as an exciting core and a detection core. An exciting coil is wound in a circumferential direction along a circumferential inner peripheral surface of the ring core. A plurality of magnetic pole projections project radially and inward from the circumferential inner peripheral surface of the ring corer, and the detection coils are wound around the respective magnetic pole projections. Accordingly, a plurality of detection coils can be arranged without increase in size or cost of the sensor. Since the exciting coil 3 is wound in the circumferential direction, magnetic characteristics along the circumferential direction can be equalized. Hence, a torque sensor is obtained which is capable of conducting a torque detection with high accuracy.

### BACKGROUND OF THE INVENTION

1. Field of the Invention

The present invention relates to a magnetostrictive type torque sensor for detecting a torque acting on a shaft or the like, utilizing magnetic anisotropy appeared on a magnetic body caused by application of a torque on the magnetic body.

2. Description of the Related Art

In general, when a tensile force is applied on a magnetic body having a positive magnetostrictive constant, a relative magnetic permeability thereof along a predetermined direction is increased substantially linearly by reverse magnetostrictive effect and magnetic flux is allowed to flow more easily in this direction, whereby an axis which can easily be magnetized is appeared in the magnetic body along this direction. Whereas, along a direction of the magnetic body perpendicular to the axis which can easily be magnetized, a compressive stress is generated and a relative magnetic permeability of this direction becomes smaller, so that an axis which can hardly be magnetized is appeared along this direction perpendicular to the axis which can easily be magnetized. Therefore, when a torque is applied on a shaft of magnetic material, these axes appear at ±45° relative to the longitudinal direction of the shaft,

The magnetostrictive type torque sensor detects torque making use of this principle. As shown in FIG. 12, a typical magnetostrictive torque sensor includes an exciting core 102 of a U-shaped ferromagnetic material, a detection core 103 of U-shaped ferromagnetic material, a set of exciting coils E1 and E2 wound around the leg portions of the core 102, and a set of detection coils D1 and D2 wound around the leg portions of the core 103. Tip ends of the leg portions of the respective cores 102 and 103 oppose to an object for detection, such as a shaft 108 of circular cross-section, with a given gap. The cores 102 and 103 are positioned so that the tip ends of the leg portion thereof are located at respective corners of a square, and that the tip ends of the leg portions of the core 102 is located along the longitudinal direction 108a of the shaft and those of the core 103 is located along a direction perpendicular to the longitudinal direction 108a.

When an exciting current of a predetermined excitation frequency is applied to the exciting coils E1 and E2, a magnetic flux is generated within the exciting core 102. The magnetic flux from the side of the exciting coil E2 flows into the shaft 108 via the gap. Since the magnetic flux flows easily along the direction of the axis which can easily be magnetized, along which tensile stress is generated, the amount of magnetic flux flowing into the detection coil D1 becomes different from that into the other coil D2, which cause magnetic flux to flow into the detection core 103. Depending upon change in amount of the magnetic flux with time, detection voltage is induced in the detection coils D1 and D2. Since the relative magnetic permeability of the axis which can easily be magnetized and that of the axis which can hardly be magnetized, are changed in proportion to variation of torque, the magnitude and direction of the torque acting on the shaft 108 can be detected on the basis of the detected voltage.

In order for the magnetostrictive type torque sensor to conduct a torque detection with high accuracy, the exciting core and the detection core must be positioned so that their tip ends of the leg portions face the circumferential outer surface of the shaft with a constant gap. Also, even if the sensor can be mounted accurately, the gap may be varied when the shaft is arranged eccentrically or is vibrated. This introduces error components in the detection signal to make it impossible to carry out an accurate torque detection.

Accordingly, in order to perform an accurate torque detection, it is necessary to arrange a plurality of magnetostrictive torque sensors along a circumferential direction on the circumferential outer peripheral surface of the shaft, and the outputs of these magnetostrictive torque sensors are combined to compensate the output error due to change of the gap or the like.

However, arrangement of a plurality of magnetostrictive type torque sensors inevitably causes to increase in size and cost of the sensors. In addition, the respective sensors have to be mounted so that a constant gap is obtained between each of the sensors and the shaft, so that mounting operation of the sensors becomes complicated and gap management thereof troublesome.

### SUMMARY OF THE INVENTION

The present invention has been worked out in view of the problems set forth above. It is therefore an object of the present invention to provide a highly accurate magnetostrictive torque sensor which can be easily assembled without increase in size or cost.

According to one aspect of the invention, there is provided a ring shaped magnetostrictive torque sensor which comprises:

an exciting core;

an exciting coil wound on the exciting core;

a detection core; and,

at least one detection coil wound on the detection core; wherein

the exciting core and the detection core are formed as a ring core or a ring core assembly having a plurality of magnetic pole projections projecting radially and inward from a circumferential inner peripheral surface thereof, and wherein

the exciting coil is wound in a circumferential direction along the circumferential inner peripheral surface of the ring core, and the detection coil is wound around the respective magnetic pole projections.

The exciting coil may be arranged at a center portion of the circumferential inner peripheral surface, and the magnetic pole projections around which the detection coil is wound, is arranged on both sides of the exciting coil.

Instead, the magnetic pole projections around which the detection coil is wound, may be located at a center portion of the circumferential inner peripheral surface, and the exciting coil is arranged on both sides of the magnetic pole projections.

In a preferred embodiment, the ring core comprises a ring shaped exciting core as the exciting core, and a ring shaped detection core as the detection core, wherein the ring shaped exciting core and the ring shaped detection core are coupled together directly or via a ring spacer of ferromagnetic material.

The ring shaped detection core may be constituted by first and second ring shaped detection cores,

the first and second ring shaped detection cores are respectively formed at their circumferential inner peripheral surfaces with the same number of sets of the magnetic pole protections projecting radially and inward at an equal angular interval, the detection coil being wound around each of the magnetic pole projections,

the exciting core is wound in a circumferential direction on the circumferential inner peripheral surface of the exciting core, and

the first and second ring shaped detection cores are arranged in a manner that the exciting core is sandwiched between them and that the respective sets of the magnetic pole projections between the first and second ring shaped detection cores are arranged at an equal angular interval along a circumferential direction, and

the exciting core and the first and second ring shaped detection cores are coupled together.

Likewise, the ring shaped exciting core may be constituted by first and second ring shaped exciting cores,

the exciting coil is wound in a circumferential direction along circumferential inner peripheral surfaces of the first and second ring shaped exciting cores,

the ring shaped detection core is formed at its circumferential inner peripheral surface with a plurality of sets of the magnetic pole projections projecting radially and inward at an equal angular interval, the detection coil being wound around the respective magnetic core projections, and

the ring shaped detection core and the first and second ring shaped exciting cores are coupled together in a manner that the ring shaped detection core is sandwiched between the first and second ring shaped exciting cores.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is an illustration showing a general construction of a ring shaped magnetostrictive type torque sensor according to the present invention;

FIG. 2 is an illustration showing a general construction of another ring shaped magnetostrictive type torque sensor according to the present invention;

FIGS. 3A and 3B are illustrations showing general construction of the first embodiment of a ring shaped magnetostrictive type torque sensor, to which the present invention is applied;

FIG. 4A is a right side view of the torque sensor of FIGS. 3A and 3B;

FIG. 4B is a section taken along line A-A of FIG. 4A;

FIG. 4C is a left side view of the torque sensor of FIGS. 3A and 3B;

FIGS. 5A to 5E are illustrations showing respective components of the torque sensor of FIGS. 3A and 3B;

FIG. 6 is an explanatory illustration showing an example of wiring connection of a detection coil in the torque sensor of FIGS. 3A and 3B;

FIG. 7 is an explanatory illustration showing an example of wiring connection of a detection coil in the torque sensor of FIGS. 3A and 3B;

FIG. 8 is a schematic block diagram showing a signal processing circuit of the torque sensor of FIGS. 3A and 3B;

FIG. 9A is a partial longitudinal section of the second embodiment of the ring shaped magnetostrictive type torque sensor, to which the present invention is applied;

FIG. 9B is a left side view of the torque sensor of FIG. 9A;

FIG. 9C is an enlarged partial view showing arrangement of cores as viewed from shaft side;

FIG. 10A is a right side view of the torque sensor of FIGS. 9A to 9C;

FIG. 10B is a section taken along line B-B of FIG. 10A;

FIG. 10C is a left side view of the torque sensor of FIGS. 9A to 9C;

FIGS. 11A to 11C are illustrations showing components of the torque sensor of FIGS. 9A to 9C; and

FIG. 12 is a perspective view showing a general construction of the magnetostrictive sensor as typically used.

### DESCRIPTION OF THE PREFERRED EMBODIMENT

The present invention will be discussed hereinafter in detail in terms of the preferred embodiment of a ring shaped magnetostrictive torque sensor according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

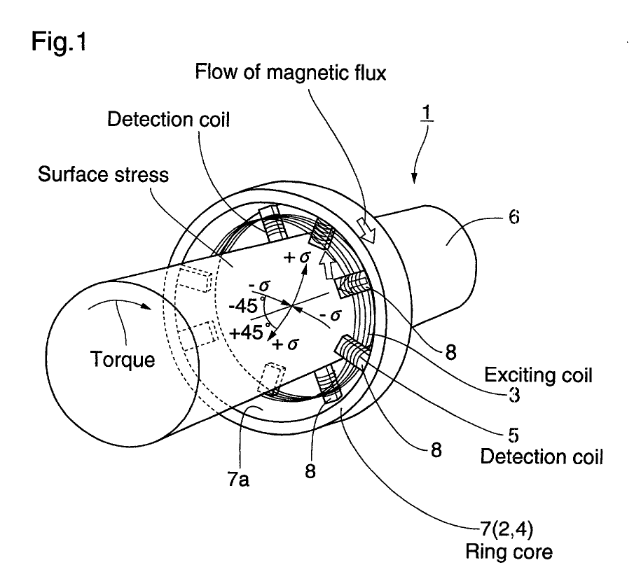

FIG. 1 shows a general construction of one ring shaped magnetostrictive torque sensor according to the present invention. The magnetostrictive torque sensor 1 includes an exciting coil 3 wound around an exciting core 2 and a detection coil 5 wound around detection cores 4. The magnetostrictive torque sensor 1 detects a torque applied to an object 6, such as a shaft, for measurement on the basis of variation of magnetic characteristics of the object. The exciting core 2 and the detection cores 4 are formed as a single ring core 7. The exciting core 3 is wound in a circumferential direction along the circumferential inner peripheral surface 7a of the ring core 7, and the detection coil 5 is wound around a plurality of magnetic pole projections 8 extending radially and inward from the circumferential inner peripheral surface 7a of the ring core 7.

In the construction shown in FIG. 1, the exciting coil 3 is arranged at the center portion in the width direction of the circumferential inner peripheral surface 7a of the ring core 7 and the magnetic pole projections 8 are arranged on both sides of the exciting coil 3 in the width direction of the surface 7a.

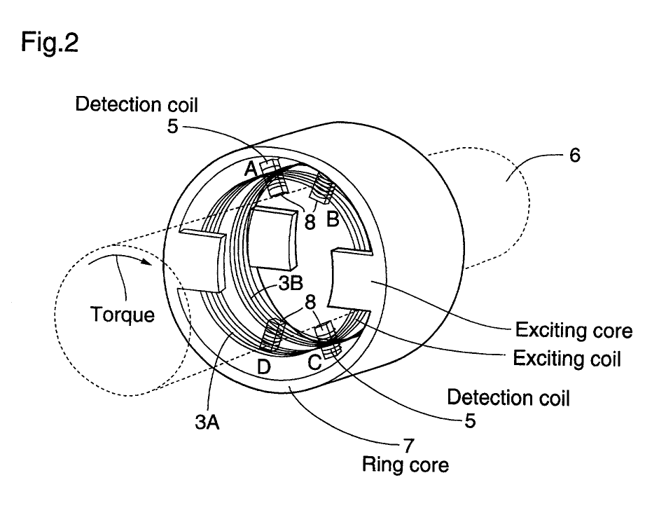

Instead, as shown in FIG. 2, it is possible to arrange the magnetic pole projections 8 at the center portion on the inner peripheral surface 7a of the ring core 7, and to arrange the exciting coils 3A and 3B on both sides of the magnetic pole projections 8.

Next, instead of forming the ring core as a single member, it can be an ring core assembly constituted by a ring shaped exciting core as the exciting core and a ring shaped detection core as the detection core. In this case, the ring shaped exciting core and the ring shaped detection core may be coupled together directly or via a ring shaped spacer formed of magnetic material so as to constitute the ring core asembly.

The ring shaped detection core may be constituted by first and second ring shaped detection cores. In this case, the first and second ring shaped cores are formed at their inner peripheral surface with the same number of magnetic pole projections in a manner that they are projected from radially and inward at equal angular intervals along the circumferential inner peripheral surface of the cores. The detection coils are wound around the respective magnetic pole projections, and on the inner peripheral surface of the exciting core, the exciting coil is wound along the circumferential direction of the circumferential inner peripheral surface of the exciting core. Furthermore, interpositioning the exciting core, the first and second ring shaped detection cores are coupled with each other in the condition where the respective sets of the magnetic pole projections are arranged at equal angular intervals.

On the other hand, the ring shaped exciting core may also be constituted by first and second ring shaped exciting cores. In this case, the detection coils are wound in the circumferential direction along the inner peripheral surfaces of the first and second ring shaped exciting cores. A plurality of sets of the magnetic pole projections projecting radially inward from the inner peripheral surface of the exciting core may be provided with equal angular interval, and the detection coils may be wound around the respective magnetic core projections. Then, the first and second exciting cores are coupled with interpositioning the ring shaped detection core.

Further detail of the present invention will be discussed hereinafter in terms of the preferred embodiments.

First Embodiment

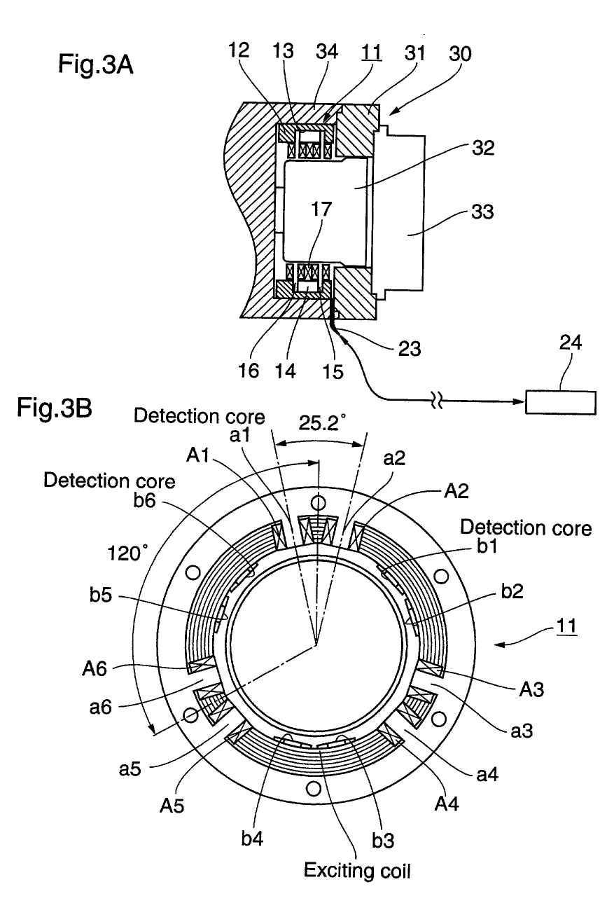

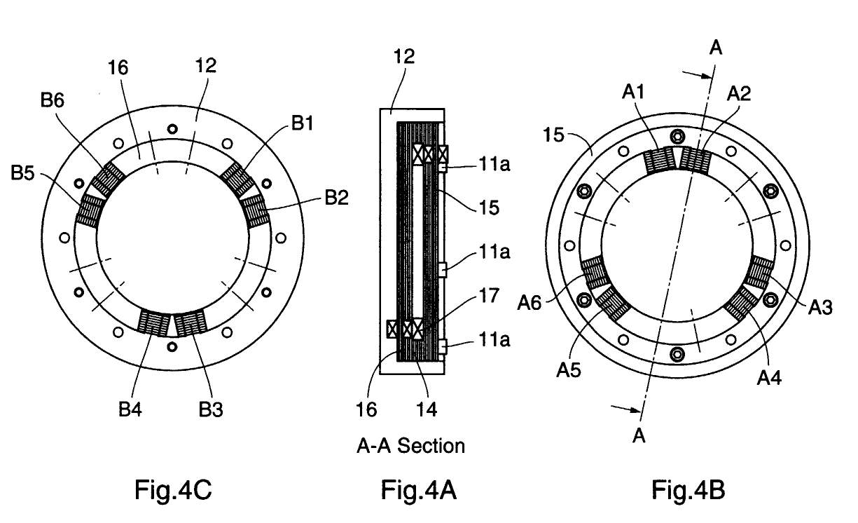

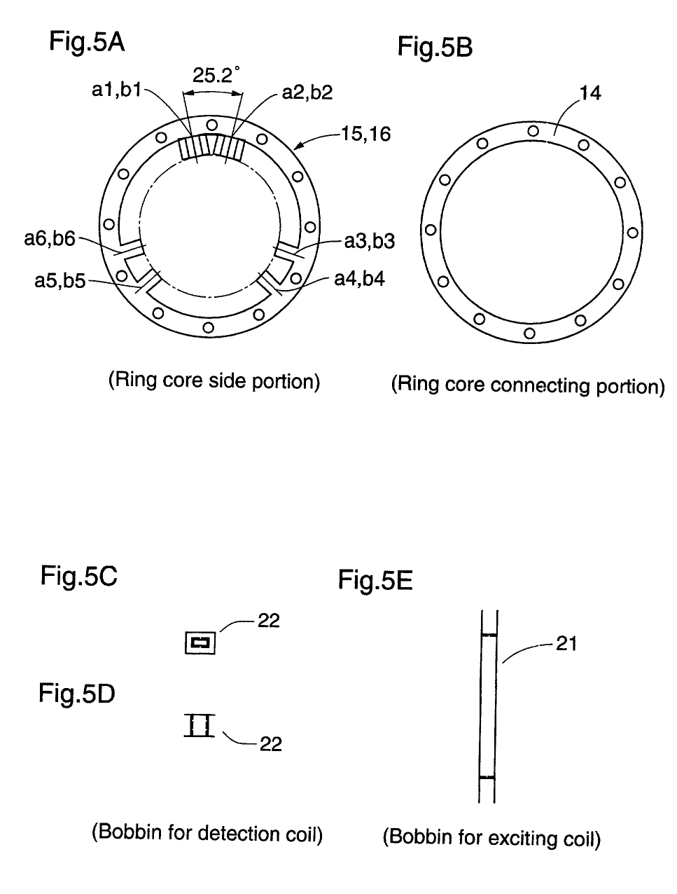

FIGS. 3A and 3B are illustrations showing general construction of the first embodiment of a ring shaped magnetostrictive type torque sensor, to which the present invention is applied. FIG. 4A is a right side view of the torque sensor of FIGS. 3A and 3B, FIG. 4B is a section taken along line A-A of FIG. 4A, and FIG. 4C is a left side view of the torque sensor of FIGS. 3A and 3B. FIGS. 5A to 5E are illustrations showing respective components of the torque sensor of FIGS. 3A and 3B.

As shown in these drawings, the shown embodiment of the ring shaped magnetostrictive type torque sensor 11 has a circular sensor mounting substrate 12 which is formed at its inner peripheral surface with an annular groove 13. In the groove 13, a first ring shaped detection core 15 and a second ring shaped detection core 16 (FIG. 5A) are arranged in a manner that a ring shaped exciting core 14 (FIG. 5B) is sandwiched between them, These three cores 14, 15 and 16 are rigidly coupled together by means of fastening screws 11a, to thereby form a ring core assembly.

On the circumferential inner peripheral surface of the ring shaped exciting core 14, an exciting coil 17 is wound in the circumferential direction. Namely, on the inner side of the ring shaped exciting core 14, an exciting coil bobbin 21 (FIG. 5E) is accommodated inside the ring shaped exciting core 14, which has a size fitted on the circumferential inner peripheral surface of the core. The exciting coil 17 is wound around the bobbin 21 by a predetermined number of turns.

The first and second detection cores 15 and 16 have the identical structure, and are formed on their inner peripheral surfaces with three sets of magnetic pole projections, respectively along the circumferential direction at an angular interval of 120°. Namely, three sets of magnetic pole projections a1 and 2a, a3 and a4, and a5 and a6 are formed on the first detection core 15, while those of b1 and b2, b3 and b4, and b5 and b6 are formed on the second detection core 16. On these magnetic pole projections a1 to a6 and b1 to b6, detection coils A1 to A6 and B1 to B6 are wound via detection coil bobbins 22 (FIGS. 5C and 5D).

The first and second ring shaped detection cores 15 and 16 of the identical structure are assembled in a condition offsetting at 60° in the circumferential direction relative to each other. Therefore, each set of the magnetic pole projections a1 to a6 and b1 to b6 are also offset at 60° relative to each other.

FIGS. 3A and 3B show the ring shaped magnetostrictive torque sensor in a condition mounted on a wave gear reduction device. The wave gear reduction device 30 has an annular rigid internal gear 31, a flexible external gear 32 and a wave generator 33 for flexing the external gear 32 into elliptical shape to mesh it partially with the rigid internal gear and for shifting the meshing portions along a circumferential direction. Typically, the wave generator 33 is taken as an input element and the flexible external gear 32 as an output element.

The shown embodiment of the ring shaped magnetostrictive torque sensor 11 is mounted on the circumferential inner peripheral surface of a cylindrical reduction device housing 34, on which the rigid internal gear 31 is mounted. The sensor 11 is arranged so that the magnetic pole projections a1 to a6 and b1 to b6 are set to face an outer peripheral surface of the flexible external gear 32 with a prescribed gap, and detects a torque acting on the external gear 32. An output of the ring shaped magnetostrictive torque sensor 11 is supplied to a signal processing circuit 24 arranged outside through a signal line 23 lead out from the housing 34. In the signal processing circuit 24, torque calculation is performed on the basis of the sensor output.

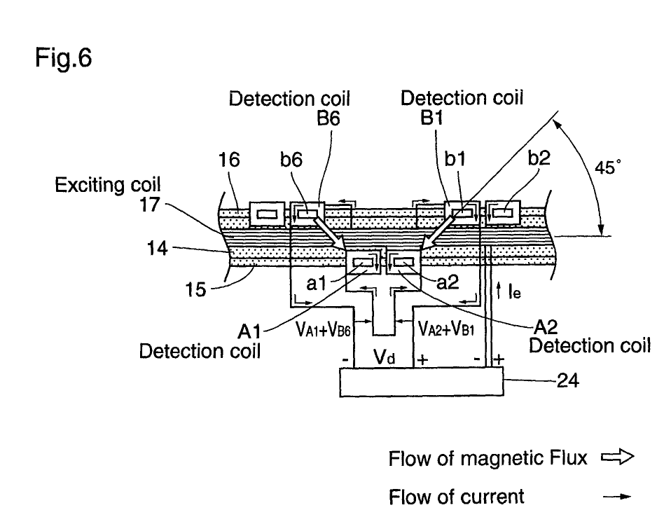

When a torque is applied to the flexible external gear 32 as an object to be detected, along directions of ±45° relative to an axial direction (longitudinal direction) of the external gear 32 is appeared an axis which can easily be magnetized, and along directions perpendicular to this axis is appeared an axis which can hardly be magnetized. As a result, a magnetic flux flowing along the surface to be measured is changed. In the shown embodiment of the ring shaped magnetostrictive torque sensor 11, when serial wiring of the detection coils A1, A2, B1 and B6 in this order is employed as shown in FIG. 6, for example, if torque is applied, magnetic fluxes flowing into the detection coils A1 and A2 shown in FIG. 6, are changed. By taking the difference between voltages induced in the detection coils A1 and A2, the applied torque can be detected as an output voltage.

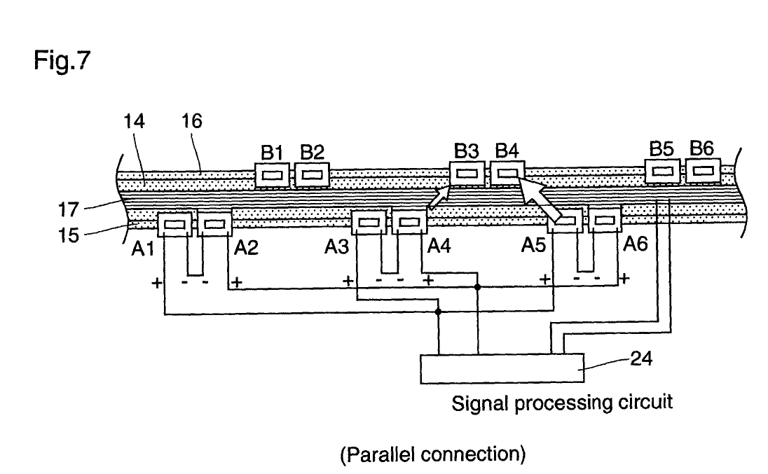

It is also possible to connect the detection coil pairs A1 and A2, A3 and A4, A5 and A6 on the side of the first ring shaped detection core in parallel, as shown in FIG. 7.

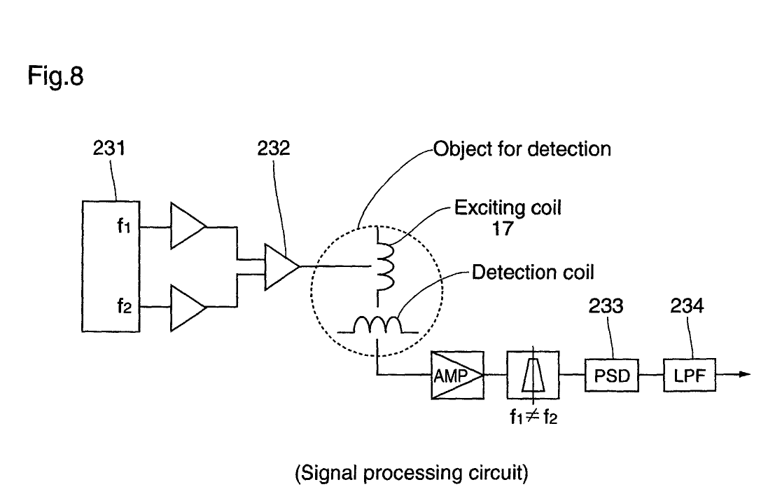

It should be noted that a construction of the signal processing circuit 23 as shown in FIG. 8 can be employed. In the shown signal processing circuit 23, two kinds of electrical current from an oscillator 231 having different frequencies, are combined by an adder circuit 232, an output current from which is applied to the exciting coil 17. Since the voltage, in which two kinds of frequencies are combined, is detected by the detection coils, a voltage of one of the frequency components is taken out by a frequency spectrum. Next, by means of a phase detector (PSD) 233, the detected voltage is converted into a direct current voltage. The direct current voltage then passes through a low-pass filter (LPF) 234 to obtain a detection output.

The above method in which a current having two frequency components is applied and a detection voltage of one of the frequency components is derived, is called as dither method. This method has been confirmed as effective for reducing hysteresis of ferromagnetic body as well as demagnetizing method and magnetic shaking method. Accordingly, such a signal processing circuit is preferred for capability of reduction of fluctuation of output in dynamic torque measurement.

In the shown embodiment of the ring shaped magnetostrictive torque sensor constructed as set forth above, such a structure is employed, in which the ring shaped exciting core and the ring shaped detection core are laminated. Therefore, it can be produced by a simple process, or press work to laminate silicon steel plates as a ferromagnetic body, for example. Also, the magnetostrictive torque sensor can be thin and compact construction.

Furthermore, since the exciting coil is wound in the circumferential direction along the inner peripheral surface of the ring shaped exciting core, the exciting coil can be magnetized under substantially the same magnetizing condition along the circumferential direction. In addition, unevenness in the circumferential direction (unevenness of magnetizing condition, unevenness of residual magnetism or the like) may be equalized.

Furthermore, it becomes possible to arrange a large number of detection coils in the circumferential direction to perform torque detection by combining the outputs from the detection coils without increase in size or cost. In addition, it becomes unnecessary to increase the number of the exciting coil corresponding to the number of detection coils. Accordingly, detection error caused by fluctuation of gap due to run-out of detection object can be compensated without arranging a plurality of sets of the magnetostrictive sensors of identical construction, namely without arranging a large number of the detection cores, the detection coils and the exciting cores and the exciting coils. Therefore, the torque sensor which is small in size, compact and capable of accurately detecting torque, can be realized.

Second Embodiment

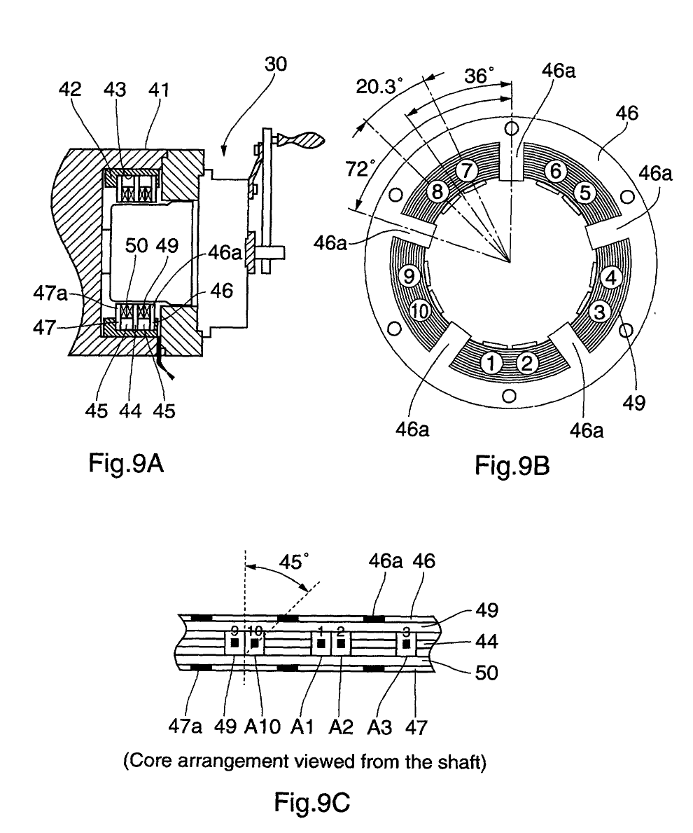

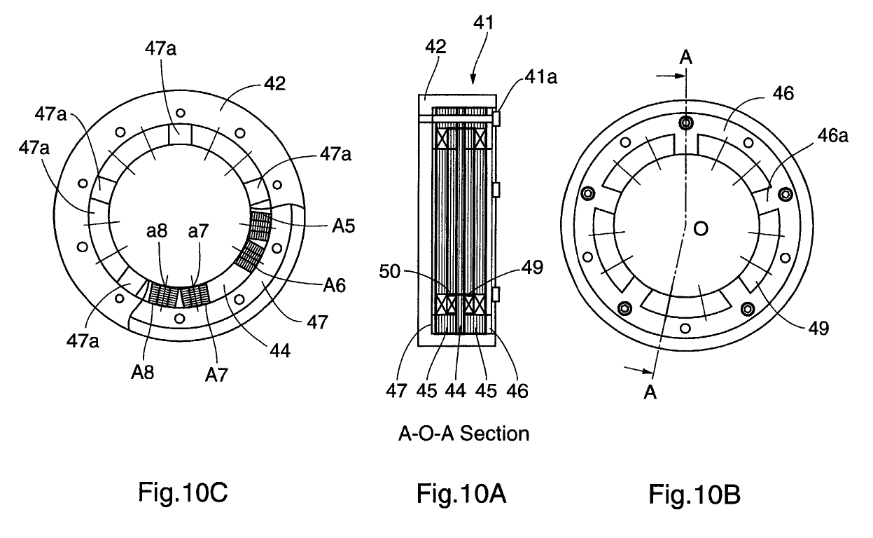

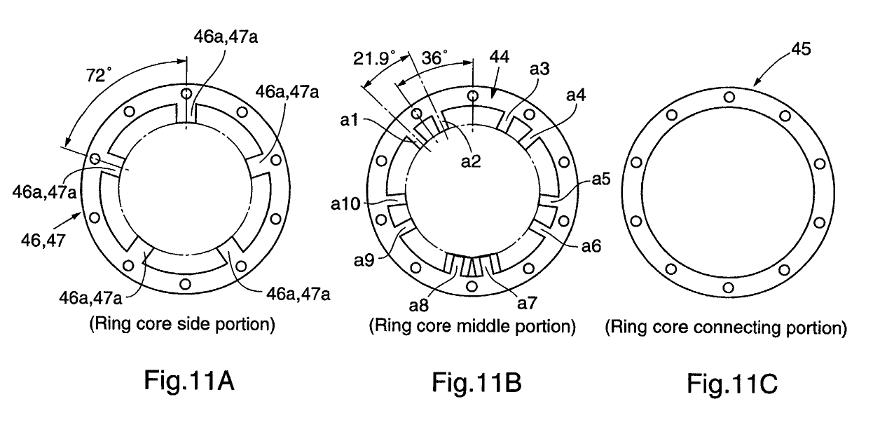

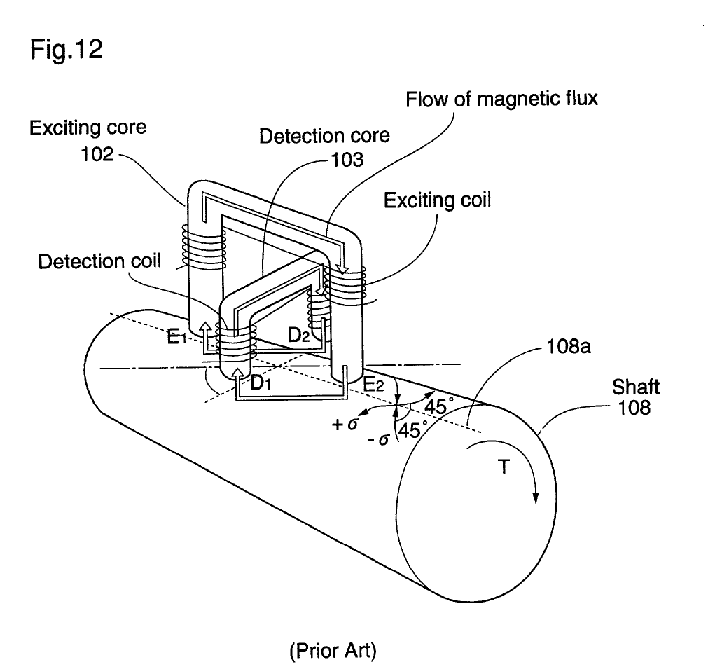

FIG. 9A is a partial longitudinal section of the second embodiment of the ring shaped magnetostrictive type torque sensor, to which the present invention is applied, FIG. 9B is a left side view of the torque sensor of FIG. 9A, and FIG. 9C is an enlarged partial view showing arrangement of cores as viewed from shaft side. FIG. 10A is a right side view of the torque sensor of FIGS. 9A to 9C, FIG. 10B is a section taken along line B-B of FIG. 10A, and FIG. 10C is a left side view of the torque sensor of FIGS. 9A to 9C. FIGS. 11A to 11C are illustrations showing components of the torque sensor of FIGS. 9A to 9C.

As shown in these drawings, the shown embodiment of the ring shaped magnetostrictive type torque sensor 41 has a circular sensor mounting substrate 42 formed on its inner peripheral surface with an annular groove 43, in which there are provided a ring shaped detection core 44 (FIG. 11B), ring spacers 45 (FIG. 11C) formed of magnetic material, and first and second ring shaped exciting cores 46 and 47 (FIG. 11A). The ring spacers 45 are placed on both sides of the detection core 44, and the first and second ring shaped exciting cores 46 and 47 are placed so as to sandwich these three members between them. The assembled five members firmly coupled by means of fastening bolts 41a, to thereby form a ring core assembly.

The first and second exciting cores 46 and 47 located at both sides have the same construction. On the inner periphery sides, namely on the inner peripheral surface of the ring spacer 45 formed of magnetic material and located adjacent to the cores 46 and 47, first and second exciting coils 49 and 50 are wound along the circumferential direction of the spacers 45. The ring shaped exciting cores 46 and 47 are formed on their inner peripheral surfaces with five core projections 46a and 47a, respectively The core projections 46a are formed at a regular angular interval of 72° in the shown embodiment, along the circumferential direction. Likewise, the other core projections 47a are also arranged at the same angular interval along the circumferential direction.

The ring shaped detection core 44 is formed on its circumferential inner surface with five pairs of magnetic pole projections a1 and a2, a3 and a4, a5 and a6, a7 and a8, and a9 and a10. These pairs are arranged at an equal angular interval, i.e. 72° in the shown embodiment, along the circumferential direction. On these magnetic pole projections a1 to a10, detection coils A1 to A10 are wound. Namely, in the shown embodiment, five sets of magnetic poles are formed.

Here, relative to the first and second ring shaped exciting cores 46 and 47 having the identical structure, the ring shaped detection core 44 interpositioned between the first and second ring shaped exciting cores, is assembled with a relative angular offset of 36° in the circumferential direction.

In FIGS. 9A to 9C also, similar to FIGS. 3A and 3B, the ring shaped magnetostrictive torque sensor 41 is shown in the condition mounted on the wave gear reduction device 30. When torque is not applied, magnetic flux flowing into the flexible external gear 32 from the exciting cores 46 and 47 at both sides, does not flow to the detection core 44, substantially. However, when the torque is applied, due to influence of reverse magnetostrictive effect, the difference in amount of magnetic fluxes flowing along the directions of ±45° relative to the axial direction of the flexible external gear 32 is appeared. Therefore, magnetic flux proportional to the torque flows through the detection core 44. It should be noted that positive torque and negative torque can be discriminated whether the induced voltage of the detection coil is advanced or retarded at 90° with respect to the phase of the exciting current.

As set forth above, even with the shown embodiment of the magnetostrictive torque sensor 41, similar effect as the magnetostrictive torque sensor 11 can be attained. In addition, the shown embodiment of the torque sensor 41 employs a construction where the detection core 44 is sandwiched by the exciting cores 46 and 47, the magnetic field generated by the detection core 44 is shielded by the exciting cores 46 and 47 so as not to affect externally.

As set forth above, the ring shaped magnetostrictive torque sensor employs a construction to form the exciting core and the detection core into the ring cores to wind the exciting coils in the circumferential direction along the inner periphery of the ring core, and the detection coils are wound around a plurality of magnetic pole projections formed on the inner periphery of the ring core. Accordingly, with the present invention, it becomes possible to arrange a large number of detection coils in circumferential direction to perform torque detection by combining the outputs from the detection coils without causing increase of dimensional size and cost and whereby the torque sensor small in size, compact and capable of precisely detecting torque, can be realized.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A ring shaped magnetostrictive torque sensor comprising:
an exciting core;
an exciting coil wound on the exciting core;
a detection core; and,
at least one detection coil wound on the detection core; wherein
the exciting core and the detection core are formed as a ring core or a ring core assembly which has a plurality of magnetic pole projections projecting radially and inward from a circumferential inner peripheral surface thereof, and wherein
the exciting coil is wound in a circumferential direction along the circumferential inner peripheral surface of the ring core, and the detection coil is wound around the respective magnetic pole projections.

2. A ring shaped magnetostrictive torque sensor as set forth in claim 1, wherein the exciting coil is arranged at a center portion of the circumferential inner peripheral surface, and the magnetic pole projections around which the detection coil is wound, is arranged on both sides of the exciting coil.

3. A ring shaped magnetostrictive torque sensor as set forth in claim 1, wherein the magnetic pole projections around which the detection coil is wound, is located at a center portion of the circumferential inner peripheral surface, and the exciting coil is arranged on both sides of the magnetic pole projections.

4. A magnetostrictive torque sensor as set forth in claim 1, wherein the ring core assembly comprises
a ring shaped exciting core as the exciting core; and
a ring shaped detection core as the detection core, and wherein
the ring shaped exciting core and the ring shaped detection core are coupled together directly or via a ring spacer of ferromagnetic material.

5. A magnetostrictive torque sensor as set forth in claim 4, wherein the ring shaped detection core is constituted by first and second ring shaped detection cores,
the first and second ring shaped detection cores are respectively formed at their circumferential inner peripheral surfaces with the same number of sets of the magnetic pole projections projecting radially and inward at an equal angular interval, the detection coils being wound around each of the magnetic pole projections,
the exciting core is wound in a circumferential direction on the circumferential inner peripheral surface of the exciting core,
the first and second ring shaped detection cores are arranged in a manner that the exciting core is sandwiched between them and that the respective sets of the magnetic pole projections between the first and second ring shaped detection cores are arranged at an equal angular interval along a circumferential direction, and
the exciting core and the first and second ring shaped detection cores are coupled together.

6. A magnetostrictive torque sensor as set forth in claim 4, wherein said ring shaped exciting core is constituted by first and second ring shaped exciting cores,
the exciting coil is wound in the circumferential direction along circumferential inner peripheral surfaces of the first and second ring shaped exciting cores,
the ring shaped detection core is formed at its circumferential inner peripheral surface with a plurality of sets of the magnetic pole projections projecting radially and inward at an equal angular interval, the detection coils being wound around the respective magnetic core projections, and
the ring shaped detection core and the first and second ring shaped exciting cores are coupled together in a manner that the ring shaped detection core is sandwiched between the first and second ring shaped exciting cores.
